(19) United States
(12) Patent Application Publication
(10) Pub. No.: US 2022/0000213 A1
(43) Pub. Date: Jan. 6, 2022

(54) FOOTPLATE DEVICE FOR VIBRATING FOOTWEAR

(71) Applicant: SONICSENSORY, INC., Los Angeles, CA (US)

(72) Inventors: Richard Warren Little, LOS ANGELES, CA (US); Erik Stefansson, LOS ANGELES, CA (US); Jens Jonasson, Los Angeles, CA (US); Susan Paley, LOS ANGELES, CA (US)

(21) Appl. No.: 16/920,291

(22) Filed: Jul. 2, 2020

(51) Int. Cl. A43B 3/00; H04R 1/02

(52) U.S. Cl. CPC A43B 3/0005; H04R 2400/03; H04R 1/02

(57) ABSTRACT

Embodiments include a footplate device for placement in a piece of footwear, the footplate device including a toe portion defined at a first end of the footplate device and a heel portion defined at a second end of the footplate device opposite the first end. The device further including a flexible portion disposed between the toe portion and the heel portion, the flexible portion configured to have a first stiffness that is less than a second stiffness of the toe portion and the heel portion. The device further includes a transducer mounting portion defined within the flexible portion and a haptic transducer fixedly attached to the transducer mounting portion such that the haptic transducer causes a displacement of the flexible portion relative to the toe portion and the heel portion of the footplate device.

### BACKGROUND

Consumers of multi-media entertainment are seeking methods of heightened multi-sensory immersion. Existing systems for providing audio immersion include the use of a subwoofer to feel the low tones of music and to improve the audio of a motion picture or a video game. Existing systems also incorporate the use of surround sound to immerse the user in a more entertaining experience. Aside from audio content, these methods do not provide a multi-sensory stimulation while in a virtual reality or other audio-visual scenario. These methods are exposed in an open environment including multiple stands, wires, and other devices that impart stimuli and are used by more than one person at a time. Furthermore, these methods may be damaging to the ears because they often use loud audio signals or volume to create the immersive sound and feeling. Moreover, existing systems, and sub-woofers in particular, are not convenient for users that prefer experiencing multi-media entertainment while “on the go,” because the physical size of sub-woofer devices prevent portability. At the same time, other existing devices, such as conventional earphones, are not capable of providing the same low frequency audio effects as sub-woofers.

Another area for providing multi-sensory immersion is tactile or haptic stimulation, which can make an entertainment experience more enjoyable when combined with audio and/or audio-visual immersion. As such, vibrations generated based on audio signals of a musical piece can be synchronized with the audio signals to provide an enhanced music experience where the user both hears and feels the music. For example, haptic devices can be incorporated into footwear such that the tactile or haptic stimulation is synchronized with audio and/or audio-visual signals and the synchronized vibrations are perceived by the user wearing the footwear. Certain footwear such as shoes, sandals and the like are designed to be lightweight and provide comfort to the user. Accordingly, there is limited space within the footwear for positioning a haptic device capable of generating the tactile or haptic stimulation Additionally, certain footwear are designed to absorb forces exerted on feet in the footwear while the user is walking, running, jumping or dancing. As a result, any tactile or haptic stimulation generated by the haptic device may be dampened or attenuated within the footwear, thereby reducing vibrations perceived by the user.

Accordingly, there is a need for improved footwear that provides a personal multi-sensory experience by increasing the level of vibrational sensations generated within the footwear and perceived by the user via a foot placed into the footwear.

### SUMMARY

Various embodiments provide a footplate device configured to receive vibrations or haptic signals from a haptic transducer attached to the footplate device. The footplate device can be positioned and placed in a bottom portion of a piece of footwear, such as a shoe. The haptic transducer is attached to a flexible portion of the footplate. The flexible portion is designed or otherwise configured to enable the transmission of an increased level of vibrational sensation generated by the haptic transducer through the footplate to a foot placed in the footwear. In various embodiments, the flexible portion is configured to have a lower stiffness than the rest of the footplate device. This reduced stiffness of the flexible portion increases the flexibility of the footplate portion that is attached to the haptic transducer. As a result, the vibrations and/or haptic signals generated by the haptic transducer can be transmitted to the user's foot more effectively.

Generally, placing a haptic transducer into footwear can expand an audio event outside the confines of the head to involve the body, or at least a foot of the user, in an immersive, tactile, and portable experience. In some embodiments, the vibrations transmitted through the footplate device to the user's foot can simulate force feedback that would resonate from the ground at a live event. As a result, the footplate device with attached haptic transducer may dramatically improve the experience of listening to music, watching a movie, or playing a video game.

One example embodiment includes a footplate device for placement in a piece of footwear including a toe portion defined at a first end of the footplate device, a heel portion defined at a second end of the footplate device opposite the first end, and a flexible portion disposed between the toe portion and the heel portion, the flexible portion configured to have a first stiffness that is less than a second stiffness of the toe portion and the heel portion. The footplate device further includes a transducer mounting portion defined within the flexible portion and a haptic transducer fixedly attached to the transducer mounting portion such that the haptic transducer causes a displacement of the flexible portion relative to the toe portion and the heel portion of the footplate device.

Another example embodiment includes a piece of footwear including an outsole, a footplate device aligned with and supportingly engaged with a top surface of the outsole, the footplate device including a flexible portion disposed between a toe portion and a heel portion of the footplate device, and the flexible portion configured to have a first stiffness that is less than a second stiffness of the toe portion and the heel portion. The footplate device further includes a transducer mounting portion defined within the flexible portion, and a haptic transducer fixedly attached to the transducer mounting portion such that the haptic transducer causes a displacement of the flexible portion relative to the toe portion and the heel portion.

Yet another example embodiment includes a footplate device for a piece of footwear, the footplate device including a flexible portion configured to have a first stiffness that is less than a second stiffness of a remaining portion of the footplate. The footplate device further includes a transducer mounting portion defined within the flexible portion and a haptic transducer fixedly attached to the transducer mounting portion such that the haptic transducer causes a displacement of the flexible portion relative to the remaining portion of the footplate device.

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

### BRIEF DESCRIPTION OF THE DRAWINGS

For a better understanding of the invention, reference may be made to embodiments shown in the following drawings. The components in the drawings are not necessarily to scale and related elements may be omitted to emphasize and clearly illustrate the novel features described herein. In addition, system components can be variously arranged, as known in the art. In the figures, like referenced numerals may refer to like parts throughout the different figures unless otherwise specified.

FIG. 1 illustrates an exploded view of an example piece of footwear in accordance with embodiments of the present disclosure.

FIG. 2A illustrates a top perspective view of a footplate included in the piece of footwear of FIG. 1, in accordance with embodiments of the present disclosure.

FIG. 2B illustrates a bottom perspective view of the footplate of FIG. 2A, in accordance with embodiments of the present disclosure.

FIG. 2C illustrates a cross-sectional view through section 2C-2C of the footplate of FIG. 2A, in accordance with embodiments of the present disclosure.

FIG. 3 illustrates a schematic view of a mechanical free-body diagram of the footplate of FIG. 2A, in accordance with embodiments of the present disclosure.

FIG. 4 illustrates a graphical view of the motion amplitude of the haptic transducer and the flexible portion of the footplate of FIG. 2A, in accordance with embodiments.

FIG. 5 illustrates an enlarged, partial top perspective view of the flexible portion of the footplate of FIG. 2A, in accordance with embodiments of the present disclosure.

FIG. 6 illustrates an enlarged, partial bottom perspective view of the flexible portion of the footplate of FIG. 2A, in accordance with embodiments of the present disclosure.

### DETAILED DESCRIPTION OF EXAMPLE EMBODIMENTS

While the footplate device and piece of footwear including the footplate device described here may be embodied in various forms, the Figures show and this Specification describes some exemplary and non-limiting embodiments of the footplate device and piece of footwear. The present disclosure is an exemplification of the footplate device and piece of footwear, and does not limit the device and system to the specific illustrated and described embodiments. Not all of the depicted or described components may be required, and some embodiments may include additional, different, and/or fewer components. The arrangement and type of the components may vary without departing from the spirit or scope of the claims set forth herein.

Certain multi-sensory devices may include one or more vibration generating devices, such as but not limited to, a haptic transducer, a resonant actuator, a piezoelectric transducer, or other such devices incorporated into the footplate device and configured to generate haptic and/or vibrational sensations of the device. In various embodiments, the vibration generating device is configured as a haptic transducer (also referred to herein as a “transducer” or “driver”) that includes a moving motor that operates according to certain physical principals similar to a moving coil audio transducer (e.g., a microphone or speaker). As such, the haptic transducer or driver can include a yoke, a magnet, a top plate, a frame or basket, a voice coil, a suspension, and a diaphragm (e.g., a cone or a dome) that work together to generate haptic signals. In certain haptic transducers the diaphragm is supported by the frame and attached to the coil. The suspension is a ring of flexible material that is attached between the frame and the coil and configured to hold the coil in position and dampening oscillations of the coil and the diaphragm, but also allow them to move back and forth freely. The yoke is at the back or bottom of the driver, and the design of the yoke affects the efficiency and stability of the magnetic assembly within the motor. The magnet sits above the yoke and is the driving force of the driver. The top plate, together with the yoke and the magnet, completes the magnetic assembly or motor of the haptic transducer.

During operation of the haptic transducer, electrical signals (e.g., current) are transmitted through the coil via one or more electrical conductors (e.g., wire, lead, contact, pad, etc.) attached to the haptic transducer. The electrical signals may include audio or haptic information. The coil forms a basic electromagnet that is suspended in a magnetic field created by the transducer magnetic assembly. The transducer motor is suspended from the coil by the suspension (e.g., a spider element) such that motion of the motor is along a central axis of the coil. Applying electrical signals to the transducer causes the coil and the motor to move back and forth, like a piston, relative to the magnetic assembly, due to changes in the electromagnet's polar orientation each time the electrical signals flowing through the coil changes direction. This movement pushes and pulls on the diaphragm attached to the coil, which causes the diaphragm to vibrate. The coil movement also drives the magnetic assembly to oscillate. In this manner, the coil may serve as an actuator for moving the diaphragm and the magnetic assembly.

Due to its mass and flexible mounting, the magnetic assembly oscillates at a relatively low frequency within the range of frequencies that are easily perceptible to a user. When the coil is excited by signals at a frequency in the resonant frequency range of the haptic transducer, the transducer will vibrate to produce haptic signals. Placing the haptic transducer in close proximity to the user's body enables the user to sense, feel, or otherwise perceive tactile sensations generated by these haptic signals. In some cases, the haptic signals are transmitted to the user through inertial vibration of an outer housing of the transducer.

Various embodiments provide a footplate configured to mount or otherwise attach a haptic transducer device to a mounting portion of the footplate, the footplate is designed or otherwise configured for placement in a shoe or other piece of footwear. In certain embodiments, the footplate is configured to transmit or transfer haptic sensations (i.e. vibrations) generated by the haptic transducer to a top side of the footplate, such that when the footplate is placed in footwear, the footplate and haptic transducer provide a compact and sensitive driver system capable of effectively providing haptic sensations (or vibrations) to the user (e.g., the wearer of the shoe). For example, the haptic transducer device described in co-owned U.S. patent application Ser. No. 15/659,349, and/or the haptic transducer device described in co-owned U.S. patent application Ser. No. 16/918,867, the contents of each being incorporated by reference herein in its entirety, may be incorporated into the footplate device described herein. It should also be appreciated that while a haptic transducer is described herein, other types of transducers or devices capable of generating vibrational sensations may be utilized with the footplate instead.

In various embodiments, the footplate device described herein has an overall compact design and increased sensitivity due to certain design considerations. First, the footplate includes a transducer mounting point defined within a flexible portion of the footplate, the flexible portion having increased flexibility relative to other portions of the footplate. Second, the haptic transducer is mounted to the transducer mounting point in a manner that maximizes contact between the haptic transducer and the footplate, such that haptic sensations generated by the transducer are transmitted to the footplate with increased effectiveness. Third, the increased flexibility of the flexible portion is provided by removing material from certain areas of the footplate, which also increases user sensitivity to, or perception of, the haptic and/or vibrational sensations transmitted through the footplate. Fourth, the transducer mounting point is surrounded by an open area defined by the footplate and is connected to the other portions of the footplate by one or more arms extending through the open area. This configuration enables free excursion of the haptic transducer relative to the footplate, which can increase transmission of haptic and/or vibrational sensations to the foot of the user. Fifth, an orientation of the haptic transducer within the footplate is such that the haptic and/or vibrational sensations are transmitted vertically towards the footplate, which helps reduce the overall height of the footplate and therefore, the shoe.

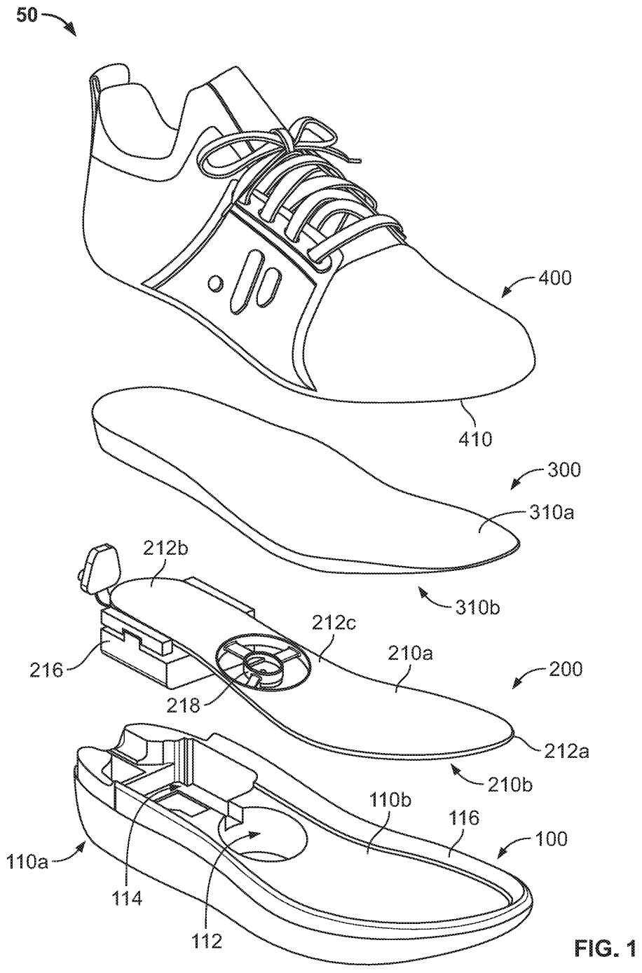

FIG. 1 illustrates an exploded view of an example piece of footwear 50 (also referred to herein as “footwear” or “shoe”) in accordance with embodiments. In the illustrated example embodiment, the footwear 50 includes an outsole 100, a footplate device 200 (also referred to herein as a “footplate”) positioned on top of the outsole 100, an insole 300 positioned on top of the footplate 200, and an upper portion 400 fixedly attached to the outsole 100 such that the upper portion 400 encloses the footplate 200 and the insole 300 within the footwear 50.

As shown in the illustrated example embodiment, the outsole 100 has an outer surface 110a and an inner surface 110b that each run along at least a portion of the length and width of the outsole 100. In various embodiments, the outer surface 110a is configured to contact the surface (e.g., the ground, floor, or other such surface) that the user comes into contact with while wearing and/or using the footwear 50. The inner surface 110b. is configured to supportingly engage the footplate 200 of the footwear 50. That is, upon installation, the footplate 200 is supported by and in contact with the inner surface 110b of the outsole 100.

In the illustrated example embodiment, the inner surface 110b also defines a first cavity 112 and a second cavity 114 of the outsole 100. In various embodiments, the outsole 100 defines a thickness between the inner surface 110b and the outer surface 110a, and the first and second cavities 112 and 114 extend through at least a portion of the thickness of the outsole 100. Upon manufacture of the footwear 50, the first and second cavities 112 and 114 are configured to provide a desired space within the outsole 100 for components of the footwear 50. It should be appreciated that while the outsole 100 defines two cavities, a different number of cavities (larger or smaller number) in the outsole 100 is possible.

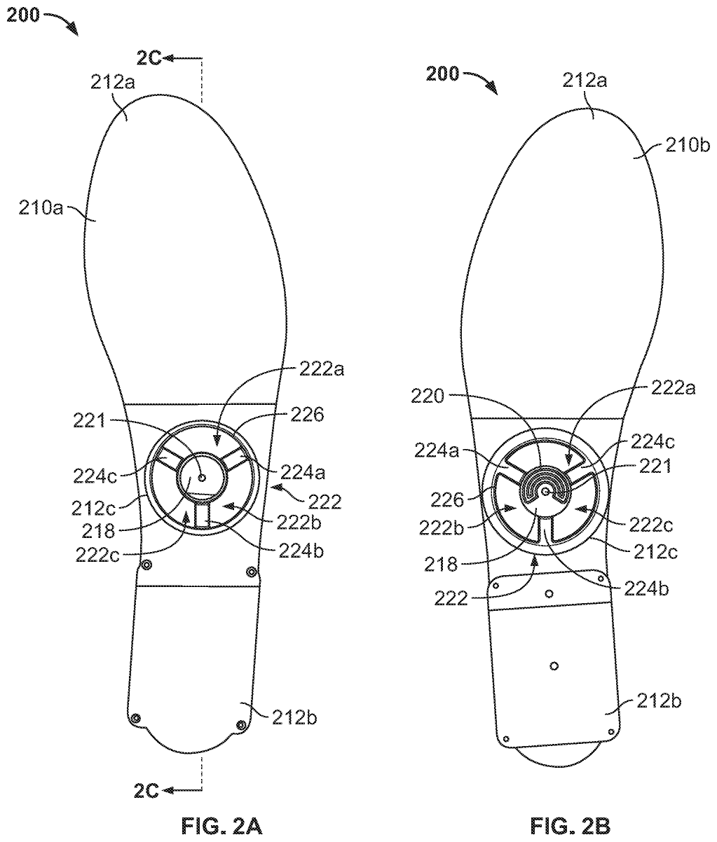

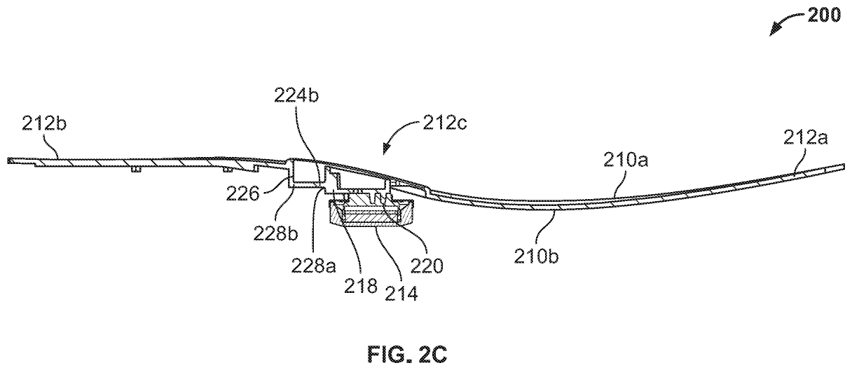

In the illustrated example embodiment, the footplate 200 includes a top surface 210a and a bottom surface 210b. The footplate 200 further defines a toe portion 212a, a heel portion 212b, and a flexible portion 212c. In the illustrated example embodiment, the flexible portion 212c is disposed between the toe portion 212a and the heel portion 212b, however it should be appreciated that other positions and/or placements of the flexible portion 212c are possible. In the illustrated example embodiment, the footplate 200 includes a haptic transducer 214 (as illustrated in FIG. 2C and also referred to herein as a “transducer”) operatively connected to the flexible portion 212c of the footplate 200. More specifically, the haptic transducer 214 is connected or otherwise attached to the bottom surface 210b of the flexible portion 212c. During use and/or operation of the footwear 50, the haptic transducer 214 is configured to generate haptic signals (e.g., vibrations) that are transmitted or directed from the haptic transducer 214 to the flexible portion 212c of the footplate 200.

In the illustrated embodiment, the footplate 200 also includes an electronic component housing 216 operatively connected to the bottom surface 210b of the footplate 200. The electronic component housing 216 is configured to provide an enclosure for components such as but not limited to, a battery, a circuit board, a communication module (e.g., Wi-Fi module, Bluetooth module, Near-Field Communication (NFC) module, and the like) and other such electronic components utilized by the footwear 50. Upon manufacture of the footwear 50, the footplate 200 is aligned with and positioned on the inner surface 110b of the outsole 100 such that the haptic transducer 214 and the electronic component housing 216 are enclosed within at least a portion of the first and second cavities 112 and 114, respectively. In various embodiments, an adhesive or other such material is placed between the footplate 200 and the inner surface 110b of the outsole to fixedly attach the footplate 200 to a desired position of the inner surface 110b of the outsole 100.

In various embodiments, the footplate 200 is positioned between the outsole 100 and the insole 300 of the footwear 50. The haptic transducer 214 is attached to the footplate 200 such that vibration generated by the haptic transducer 214 is transmitted to the footplate 200, through the insole 300 to act upon the sole of the foot within the footwear 50. Accordingly, the footplate 200 serves to provide an attachment point for the haptic transducer 214, as well as provide a flexible component capable of transmitting vibrational sensations from the haptic transducer 214 to other portions of the footwear 50. Accordingly, various embodiments of the footplate 200 are formed or otherwise constructed from a flexible and moldable material such as nylon (e.g., grade PA11) or other plastic material capable of providing a flexible attachment point for the haptic transducer 214. Additionally, it should be appreciated that certain design considerations are contemplated such as but not limited to, material stiffness, moldability, yield strength, fatigue strength, and cost, when selecting an appropriate material of the footplate.

In the illustrated example embodiment, the insole 300 includes a top surface 310a and a bottom surface 310b. The top surface 310a of the insole 300 engages with and provides support to the user's foot while wearing the footwear 50, and the bottom surface 310b operatively engages with the top surface 210a of the footplate 200 so that the user's foot is able to sense or perceive the haptic vibrations generated by the haptic transducer 214 and transmitted to the flexible portion 212c of the footplate 200. As shown in FIG. 1, the insole 300 has a shape that generally corresponds to the shape of the underlying footplate 200. In various embodiments, the insole 300 is formed from a foam material that provides comfort and support to the user while also enabling transmission of haptic vibrations generated by the haptic transducer 214. .

In the illustrated example embodiment, the upper portion 400 is attached to the outsole 100 such that the upper portion 400 encloses the insole 300 and the footplate 200 within the footwear 50. As such, in the illustrated example, the outsole 100 includes a perimeter edge 116 defined around a perimeter of the inner surface 110b of the outsole 100. Upon manufacture of the footwear 50, a lower edge 410 of the upper portion 400 corresponds with and is aligned along the perimeter edge 116 of the outsole 100. In various embodiments, the lower edge 410 of the upper portion 400 is fixedly attached to the perimeter edge 116 of the outsole by a stitching, an adhesive, a combination thereof, or other suitable attachment method.

As discussed above and shown in FIGS. 2A, 2B, 2C, 5, and 6, the flexible portion 212c of the footplate 200 includes a transducer mounting portion 218 configured to attach the transducer 214 to the flexible portion 212c of the footplate 200. In various embodiments, the transducer mounting portion 218 includes a tongue portion 220 extending out from the bottom surface 210b of the transducer mounting portion 218, and the haptic transducer 214 includes a corresponding attachment groove (not shown) integrated into a top surface of the haptic transducer 214 for coupling to the tongue portion 220. For example, the tongue portion 220 of the haptic transducer mounting portion 218 and the attachment groove of the haptic transducer 214 can be configured to form a tongue and groove connection between the haptic transducer 214 and the footplate 200. Accordingly, when the footplate 200 is placed in a shoe (e.g., footwear 50), the haptic transducer 214 is oriented such that a bottom surface of the transducer 214 faces a bottom of the shoe (e.g., the outsole 100) and the top surface of the transducer 214 faces (and is attached to) the bottom surface 210b of the footplate 200. As a result, the haptic transducer 214 is positioned between the footplate 200 and the outsole 100.

In certain embodiments, an adhesive is also applied to one or more of the haptic transducer 214 and/or the footplate 200 to further secure the connecting surfaces together. In such embodiments, the adhesive is loaded in shear, rather than in tension, to provide a more reliable bond between the tongue portion 220 of the footplate 200 and the attachment groove of the transducer 214. In some embodiments, the transducer mounting portion 218 further defines a transducer mounting bore 221 such that the haptic transducer 214 may be coupled to the footplate 200 using a fastener or other suitable mechanical attachment mechanism inserted or otherwise threaded into the transducer mounting bore.

As better illustrated by the exemplary top and bottom views of the footplate 200 shown in FIGS. 2A, 2B, 5 and 6, the footplate 200 defines an open area 222 within the flexible portion 212c of the footplate 200. More specifically, the open area 222 is defined by the top surface 210a, the bottom surface 210b, and an internal wall 226 of the footplate 200 such that the open area 222 extends through the top and bottom surfaces 210a and 210b. In embodiments, material may be removed from the footplate 200 in order to create the open area 222 within the flexible portion 212c of the footplate 200.

In the illustrated example embodiment, the open area 222 is a substantially circular area (e.g., within manufacturing tolerances) defined by the top surface 210a, the bottom surface 210b, and the internal wall 226 of the footplate 200. Furthermore, the transducer mounting portion 218 is defined as a substantially circular structure (e.g., within manufacturing tolerances) having a smaller diameter than the circular open area 222 and centered within the open area 222. It should be appreciated that while the open area 222 and the transducer mounting portion 218 are defined as circular structures, other shapes of the structures are possible.

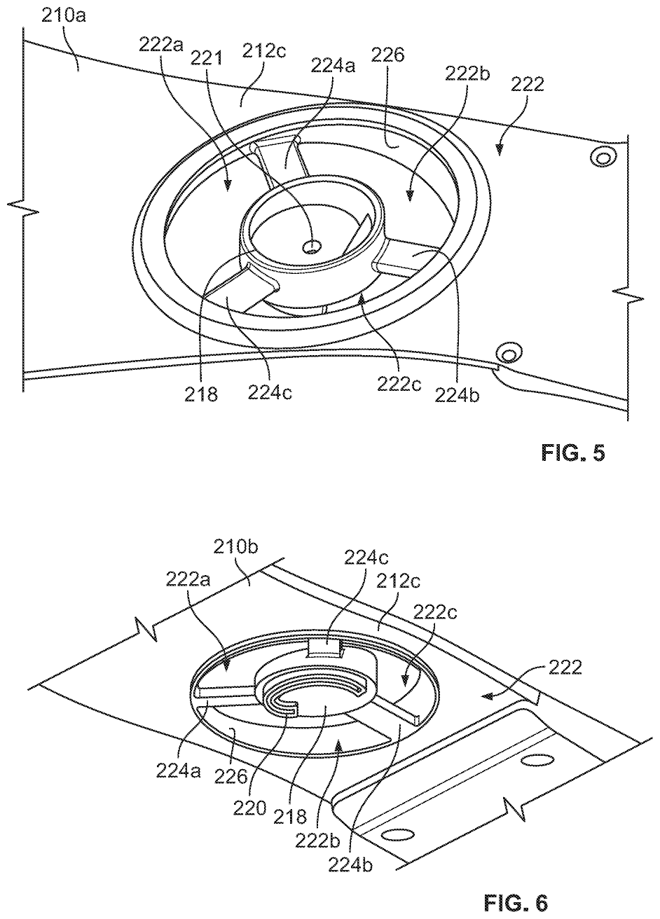

In embodiments, the flexible portion 212c can be configured to optimize a flexibility of the footplate 200, such that the vibrations generated by the haptic transducer 214 create enough displacement in the flexible portion 212c to increase the extent to which vibrational sensations are perceived by the foot of a user or wearer of the footwear containing the footplate 200. Specifically, in the illustrated example embodiment, the flexible portion 212c further includes a plurality of arms 224a, 224b, and 224c radially extending outward from the transducer mounting portion 218 to the internal wall 226 of the flexible portion 212c. That is, the arms 224a, 224b, and 224c extend through the open area 222 of the flexible portion 212c of the footplate 200. The arms 224a, 224b, and 224c are disposed between the transducer mounting portion 218 and the internal wall 226 such that a first end 228a of each arm 224a, 224b, and 224c is attached to the transducer mounting portion 218 and a second end 228b of each arm 224a, 224b, and 224c, opposite the first end 228a, is attached to at least one of the top surface 210a, the bottom surface 210b, and the internal wall 226 of the flexible portion 212c. As an example, in FIG. 5, the second end 228b of the arm 224a is shown as being attached to the internal wall 226. As a result, the transducer mounting portion 218 is suspended within the open area 222 of the flexible portion 212c and connected to the rest of the footplate 200 via the plurality of arms 224a, 224b, and 224c. While the illustrated example embodiment shows the use of three arms 224a, 224b, and 224c connected to and suspending the transducer mounting portion 218 of the footplate 200, it will be understood that a fewer or greater number of arms can be used to connect and suspend the transducer mounting portion of the footplate.

For example, in certain embodiments, a single arm can be used to connect the transducer mounting portion to the rest of the footplate. In such an embodiment, the single arm connects the transducer mounting portion and the internal wall of the footplate to form a cantilever beam-like structure extending through at least a portion of the open area of the flexible portion of the footplate. That is, the transducer mounting portion is connected to the footplate at a single attachment point (i.e., one end of the single arm). Such configuration of the flexible portion of the footplate may enable vertical motion and angular motion (caused by tilting of the transducer) of the transducer mounting portion suspended within the flexible portion of the footplate.

In certain other embodiments, two arms can be used to connect the transducer mounting portion to the rest of the footplate. In such an embodiment, the two arms are connected between the transducer mounting portion and the internal wall of the footplate. Such configuration of the flexible portion of the footplate enables vertical motion and lateral motion of the transducer mounting portion suspended within the open area of the footplate. Moreover, in certain other embodiments, more than three arms can be used to connect the transducer mounting portion the rest of the footplate. In such a configuration, the number of arms can be selected based on a desired amount of motion (or lack of motion) of the transducer mounting portion suspended within the open area of the footplate.

In the illustrated example embodiment, the arms 224a, 224b, and 224c define a plurality of open areas 222a, 222b, and 222c that surround the transducer mounting portion 218 disposed in the flexible portion 212c. More specifically, a first open area 222a (also referred to as an “open area”) is defined by arm 224a, arm 224c, a portion of the transducer mounting portion 218, and a portion of the internal wall 226. A second open area 222b (also referred to as an “open area”) is defined by arm 224a, arm 224b, a portion of the transducer mounting portion 218, and a portion of the internal wall 226. A third open area 222c (also referred to as an “open area”) is defined by arm 224b, arm 224c, a portion of the transducer mounting portion 218, and a portion of the internal wall 226.

In various embodiments, the amount of material removed from the footplate 200 to form or otherwise define the open areas 222a, 222b, and 222c of the flexible portion 212c is equal to 50% or more of the total area or region defined by the open area 222 of the flexible portion 212c. That is, after determining how many arms to utilize to connect the transducer mounting portion 218 to the rest of the footplate 200, the area that remains open is at least 50% of the total area of the flexible portion. As discussed above, in certain embodiments, the open area 222 is configured as a substantially circular area. In various embodiments, the flexible portion 212c is configured such that the diameter of the open area 222 is larger than the diameter of the haptic transducer 214 but smaller than the width of the flexible portion 212c. As such, this leaves a certain amount of footplate material between the outer circumference of the open area 222 and the edge of the footplate to provide an anchoring surface for attaching the footplate to other components of the footwear 50.

In embodiments, the placement, as well as dimensions (e.g. length, thickness, and width), of the arms 224a, 224b, and 224c can be configured to change (i.e. increase or decrease) the flexibility of the flexible portion 212c of the footplate 200. For example, the arms 224a, 224b, and 224c can be utilized to increase a flexibility of the footplate 200 to produce a desired amount or range of motion for the transducer mounting portion 218 of the flexible portion 212c of the footplate 200. In one non-limiting example, the arms 224a, 224b, and 224c are uniformly positioned at approximately (e.g., within manufacturing tolerances) 120° increments around the circumference of the transducer mounting portion 218. Such uniform positioning of the arms helps to facilitate uniform and consistent motion of the transducer mounting portion 218. While the illustrated example embodiment shows uniform positioning of arms around the transducer mounting portion, it should be appreciated that other non-uniform positioning of the arms are possible to enable a desired movement of the transducer mounting portion.

Furthermore, a length of the arms extending between the transducer mounting portion and the internal wall can be selected based on a desired stiffness of the arms and a desired amount of travel of the transducer mounting portion 218. In one non-limiting example, the arms can be configured with a length that is within 20% of an outer diameter of the transducer 214 attached to the transducer mounting portion 218. That is, the arms may extend up to 20% longer or shorter than the outer diameter of the transducer 214. In embodiments, arms that are shorter than the transducer outer diameter may have an increased stiffness compared to arms that are longer than the transducer outer diameter. In addition to adjusting arm length, adjusting other arm dimensions (e.g., thickness and/or width) can help tailor the stiffness of the arms in order to provide the desired amount of travel of the transducer mounting portion 218. For example, thinner and/or narrower arms (or spokes) may exhibit lower stiffness, while thicker arms may have increased stiffness. Thus, the length, thickness, width, or any combination thereof of the arms may be optimized to enable a certain amount of transducer travel (e.g., stiffer arms, less travel) within the flexible portion 212c of the footplate 200.

As best shown in the cross-sectional view of FIG. 2C, the top and bottom surfaces 210a and 210b of the footplate 200 are curved such that the heel portion 212b is above the toe portion 212a of the footplate 200. As a result, the footplate 200 is oriented non-parallel (or is not parallel) to the outer surface 110a of the outsole 100 of the footwear 50 shown in FIG. 1. In the illustrated example embodiment, the arms (e.g., arm 224b of FIG. 2) are in a non-planar orientation with respect to at least a portion of the top and bottom surfaces 210a and 210b of the footplate 200. That is, the arms 224a, 224b, and 224c are not disposed within the same plane as the surfaces 210a and 210b of the footplate 200. Rather, the arms are oriented such that motion of the haptic transducer 214 and the transducer mounting portion 218 is substantially vertical or along a vertical axis of the footwear 50 (i.e. up and down with respect to the outer surface 110a of the outsole 100). That is, the haptic transducer 214 and the transducer mounting portion 218 are oriented such that vibrations generated by the haptic transducer 214 cause a vertical displacement of the transducer mounter portion 218 of the flexible portion 212c.

As discussed above, various embodiments of the footplate 200 are configured to provide the flexible portion 212c with different flexibility (e.g., more or less flexible) than the remaining portions 212a and 212b of the footplate 200. In certain embodiments, the flexible portion 212c is configured to exhibit increased flexibility such that an increased level of vibrational sensation is perceived by a user's foot placed in the piece of footwear 50. For example, the flexibility of the footplate 200 can be optimized to increase a displacement of the flexible portion 212c (also referred to herein as the “footplate trampoline”) relative to the remainder of the footplate 200 in response to vibrations generated by the haptic transducer 214.

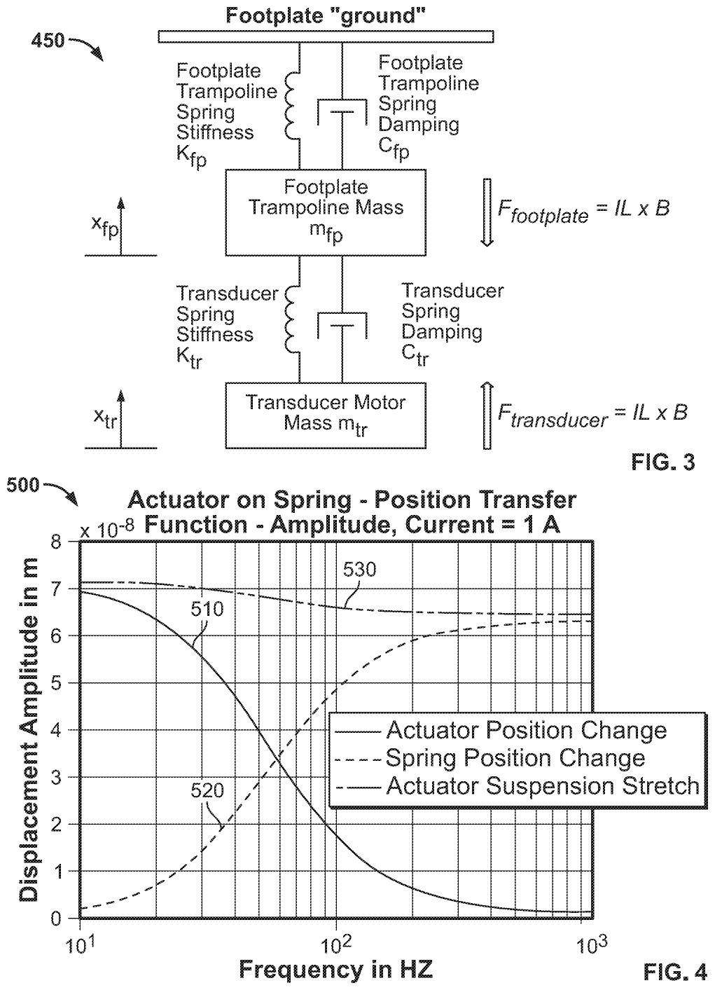

FIG. 3 provides a free-body diagram 450 of the footplate system described herein to schematically illustrate how the flexible portion of the footplate and the haptic transducer generate sufficient displacement of the footplate trampoline to transmit vibrational sensations to a foot disposed in the piece of footwear. Generally, any motion or displacement xₜᵣ of the transducer motor mass mₜᵣ (e.g., towards the footplate) induces motion or displacement x_{fp} of the footplate, or more specifically, the footplate trampoline mass m_{fp}. Said motion of the footplate trampoline is further transmitted through the insole of the footwear to act upon the sole of the foot placed in the piece of footwear. As discussed above, the footplate trampoline spring stiffness, K_{fp}, is defined by the one or more arms connecting the footplate trampoline (i.e. the transducer mounting portion) to the rest of the footplate and the transducer spring stiffness, Kₜᵣ, is defined by the transducer spring, or the suspension element of the transducer motor. Furthermore, the haptic transducer and the footplate trampoline are oriented relative to each other such that vibrations or haptic signals generated by the haptic transducer cause a vertical displacement of the trampoline portion.

As shown in FIG. 3, during operation of the footplate device, the footplate and the haptic transducer experience forces that are equal in amplitude but opposite in phase, or acting in opposite directions. That is, if the footplate trampoline is moving in an upward direction, then the transducer motor is moving in a downward direction, and vice versa. As such, the spring element between the footplate trampoline and transducer motor (i.e. the transducer spring or suspension element) is stretched by the sum of the amplitudes of the two displacements. As a result, the difference in position between the footplate trampoline and transducer motor is always larger than their individual displacement amplitudes .

FIG. 4 is a position transfer function graph 500 showing the relative positions of the haptic transducer and the transducer mounting portion during the above-described operation of the footplate device. In particular, the graph 500 shows a transducer displacement curve 510 representing the motor displacement of a haptic transducer (e.g., transducer 214 of FIG. 1), a footplate trampoline displacement curve 520 representing the displacement of a footplate trampoline coupled to the haptic transducer (e.g., transducer mounting portion 218 of FIG. 2A), and displacement difference curve 530 representing a position difference between the transducer and the footplate trampoline.

During operation there are at least two different transduction mechanisms of the footplate device 200 or system. For example, the transducer's magnetic motor experiences a first force (e.g., electromagnetic or Lorenz force) produced by current flowing through the voice coil. The voice coil experiences a second force (e.g., electromagnetic or Lorenz force) produced by the current running through the voice coil. The first force and the second force are equal in amplitude and opposite in direction.

The displacement graph 500 illustrates that the haptic transducer's motor is the primary moving component when the haptic transducer is operated at low frequencies. That is, the haptic transducer's motor remains the primary moving or displaced component until the transducer resonant frequency in the system is reached (e.g., 40 Hz). In such mode, the magnet motor motion amplitude is high, and the trampoline and voice coil motion is low. Beyond the transducer resonant frequency, the footplate device begins operating in a different mode wherein the footplate trampoline, or transducer mounting portion 218 of the flexible portion 212c, becomes the primary moving component. In such mode, the magnet motor motion amplitude is low, so much so that the motor looks like an unmoving object to the voice coil, and the trampoline and voice coil motion is high. At this point, the transducer mounting portion 218 and the voice coil of the haptic transducer 214 start acting as one vibrating unit (e.g., as the haptic transducer), and the movement or excursion of the transducer mounting portion 218 continues to increase to a maximum. Though not shown in FIG. 5, at very high frequencies (e.g., well above 1 kHz), the magnet motor motion amplitude is very low and the trampoline and voice coil motion is also low.

In various embodiments, the footplate 200 coupled to the haptic transducer 214 forms a unitary piece configured for insertion into any suitable piece of footwear, including shoes, sandals, etc. In certain embodiments, this unitary piece is included in a footwear device configured for enhancing an entertainment experience (e.g., a video game, a movie, a musical piece, etc.), and/or an entertainment system for use therewith, such as, for example, the vibrating footwear device and entertainment system described in co-owned U.S. Pat. No. 8,644,967, the contents of which are incorporated by reference herein in its entirety.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A footplate device for placement in a piece of footwear, the footplate device comprising:
a toe portion defined at a first end of the footplate device;
a heel portion defined at a second end of the footplate device opposite the first end;
a flexible portion disposed between the toe portion and the heel portion, the flexible portion configured to have a first stiffness that is less than a second stiffness of the toe portion and the heel portion;
a transducer mounting portion defined within the flexible portion; and
a haptic transducer fixedly attached to the transducer mounting portion, wherein the haptic transducer causes a displacement of the flexible portion relative to the toe portion and the heel portion of the footplate device.

2. The footplate device of claim 1, wherein the flexible portion includes an open area defined by a footplate top surface, a footplate bottom surface, and a footplate internal wall.

3. The footplate device of claim 2, wherein the open area comprises at least fifty percent of a total area of the flexible portion.

4. The footplate device of claim 2, further comprising at least one arm extending radially outward from the transducer mounting portion and extending through the open area, wherein the at least one arm includes a first end coupled to the transducer mounting portion and a second end opposite the first end coupled to at least one of the footplate top surface, the footplate bottom surface, and the footplate internal wall.

5. The footplate device of claim 4, wherein the at least one arm comprises a plurality of arms disposed around and extending radially outward from the transducer mounting portion.

6. The footplate device of claim 1, wherein the haptic transducer is configured to generate a plurality of haptic signals, and wherein the haptic transducer transmits the haptic signals to the flexible portion of the footplate device.

7. The footplate device of claim 1, wherein the flexible portion has a first diameter and the haptic transducer has a second diameter smaller than the first diameter.

8. The footplate device of claim 7, wherein the flexible portion has at least one arm extending radially outward from the transducer mounting portion, and wherein the at least one arm has a length that is greater than the second diameter of the transducer.

9. The footplate device of claim 7, wherein the first diameter of the flexible portion is at least twenty percent larger than the second diameter of the haptic transducer.

10. The footplate device of claim 1, wherein the haptic transducer causes a vertical displacement of the transducer mounting portion of the flexible portion.

11. The footplate device of claim 1, wherein the transducer mounting portion comprises a tongue portion including raised structures configured for insertion into a groove portion of the haptic transducer to form a tongue and groove attachment to the haptic transducer, the tongue portion being included on a bottom surface of the transducer mounting portion.

12. A piece of footwear comprising:
an outsole;
a footplate aligned with and supportingly engaged to a top surface of the outsole, the footplate comprising:
a flexible portion disposed between a toe portion and a heel portion of the footplate, the flexible portion configured to have a first stiffness that is less than a second stiffness of the toe portion and the heel portion,
a transducer mounting portion defined within the flexible portion, and
a haptic transducer fixedly attached to the transducer mounting portion,
wherein the haptic transducer causes a displacement of the flexible portion relative to the toe portion and the heel portion,
an insole placed on a footplate top surface; and
an upper portion connected to the outsole such that the upper portion encloses the insole and the footplate within an interior area of the piece of footwear.

13. The piece of footwear of claim 12, wherein the flexible portion includes an open area defined by the footplate top surface, a footplate bottom surface, and a footplate internal wall.

14. The piece of footwear of claim 13, further comprising at least one arm extending radially outward from the transducer mounting portion and extending through the open area, wherein the at least one arm includes a first end coupled to the transducer mounting portion and a second end opposite the first end coupled to at least one of the footplate top surface, the footplate bottom surface, and the footplate internal wall.

15. The piece of footwear of claim 12, wherein the haptic transducer causes a vertical displacement of the transducer mounting portion of the flexible portion, the vertical displacement transmitting a vibrational sensation to a foot positioned within the upper portion of the piece of footwear.

16. The piece of footwear of claim 12, wherein the transducer mounting portion comprises a tongue portion including raised structures configured for insertion into a groove portion of the haptic transducer for forming a tongue and groove attachment to the haptic transducer, the tongue portion being included on a bottom surface of the transducer mounting portion.

17. A footplate for a piece of footwear, the footplate comprising:
a flexible portion configured to have a first stiffness that is less than a second stiffness of a remaining portion of the footplate;
a transducer mounting portion defined within the flexible portion; and
a haptic transducer attached to the transducer mounting portion, wherein the haptic transducer causes a displacement of the flexible portion relative to the remaining portion of the footplate.

18. The footplate of claim 17, wherein the flexible portion includes an open area defined by a footplate top surface, a footplate bottom surface, and a footplate internal wall.

19. The footplate of claim 18, further comprising at least one arm extending radially outward from the transducer mounting portion and extending through the open area, wherein the at least one arm includes a first end coupled to the transducer mounting portion and a second end opposite the first end coupled to at least one of the footplate top surface, the footplate bottom surface, and the footplate internal wall.

20. The footplate of claim 17, wherein the transducer mounting portion comprises a tongue portion including raised structures configured for insertion into a groove portion of the haptic transducer for forming a tongue and groove attachment to the haptic transducer, the tongue portion being included on a bottom surface of the transducer mounting portion.
